(19) United States
(12) Patent Application Publication
(10) Pub. No.: US 2018/0245170 A1
(43) Pub. Date: Aug. 30, 2018

(54) A PELT BOARD BAG AND AN ASSEMBLY OF A PELT BOARD BAG AND A PELT BOARD

(71) Applicant: MINKPAPIR A/S, Holstebro (DK)

(72) Inventors: Johnny Larsen, Aalborg (DK); Henrik Palsgard, Aalborg (DK); Soren Frolund, Holstebro (DK); Mogens Fahlgren Andersen, Holstebro (DK)

(73) Assignee: MINKPAPIR A/S, Holstebro (DK)

(21) Appl. No.: 15/756,257

(22) PCT Filed: Aug. 26, 2016
(86) PCT No.: PCT/EP2016/070172

§ 371 Date: Feb. 28, 2018

(30) Foreign Application Priority Data
Aug. 28, 2015 (DK) PA 2015 00512
Mar. 30, 2016 (DK) PA 2016 00191

(51) Int. Cl. C14B 1/58; C14B 1/26; C14B 15/06

(52) U.S. Cl. CPC C14B 1/58; C14B 15/06; C14B 1/26

(57) ABSTRACT

The present invention relates to an elongated pelt board for accommodating an animal pelt. The pelt board comprises a first wall element, a second wall element being spaced apart from the first wall element in the first radial direction, a third wall element and a fourth wall element being spaced apart from the third wall element in a second radial direction. The wall elements together define a cavity along a longitudinal direction. The wall elements defining a contracted state in which the first and second radial distances are reduced, and an expanded state in which the first and second radial distances are increased. The pelt board further comprising an elongated core element being movable in relation to each of the wall elements. The elongated core element allows the wall elements to selectively define the contracted state or the expanded state by moving the elongated core element in the longitudinal direction.

### CROSS-REFERENCE TO RELATED APPLICATIONS

This application is the national phase entry, under 35 U.S.C. Section 371(c), of International Application No. PCT/EP2016/070172, filed Aug. 26, 2016, claiming priority from Danish Patent Application Nos. PA201500512, filed Aug. 28, 2015 and PA201600191, filed Mar. 30, 2016. The disclosures of the International Application and the Danish Applications from which this application claims priority are incorporated herein by reference in their entireties.

### FEDERALLY SPONSORED RESEARCH OR DEVELOPMENT

Not Applicable

The present invention relates to a pelt board bag and an assembly of a pelt board bag and a pelt board.

### BACKGROUND OF THE INVENTION

In the fur industry, animal pelts are often stretched in a non-destructive way in order to maximize the size of the pelt. The pelts define a substantially tubular shape and have an outwardly oriented fur side and an inwardly oriented leather side. The stretching takes place after skinning the animal and scraping off the layer of fat on the leather side of the pelt and before the drying of the pelt. In the present context, the word pelt is understood to encompass pelts of minks, foxes and similar small mammals. The pelts are often stretched on a pelt board, which is nowadays made of plastic as a pelt board bag is interlayered between the pelt board and the pelt. Normally, the leather side of the pelt is facing the pelt board bag, which is made from a fat absorbing and possibly also moisture absorbing material such as a paper bag or sleeve, which is in contact with the leather side of the pelt. The fur side of the pelt is thereby facing outwardly during the stretching and drying of the pelt.

The stretching procedure and the use of pelt boards are known per se and both are disclosed in e.g. WO 2005/028682 A1. Therein is disclosed the use of a gripping element which is brought in engagement with the whole periphery of the pelt and the drawing of a fixing bag over the outside of the pelt in order to maintain the pelt in a stretched configuration during the drying of the pelt. Thereby, the previous use of staples and the thus produced elongated holes in the pelts may be avoided.

In relation to the above terminology, the word bag which in its normal understanding may describe a sleeve with a closed off bottom should in the present circumstances and further along in the present patent application be understood to also encompass sleeves which are not closed off and which have a tubular or cylindrical shape without a closed off bottom.

Within the relevant technical field, numerous examples are presented in relation to improved pelt board bags, which are described among others in the applicant company's patents: DK 174852, DK 174865, EP 1 285 094, EP 1 759 022, DK 176683, U.S. Pat. No. 8,863,560, and applicant's EU design registration EU 001303085.

Further examples are presented in Danish patent 177582 and pending Danish patent application 2015 70184.

The use of a pelt board bag such as a fat and moisture absorbing pelt board bag in combination with a pelt board when tanning and drying the pelt, calls for several conflicting concerns as on the one hand, the pelt board bag should be easily applied to the pelt board and on the other hand be sticking to the pelt after finalizing the drying when the pelt is removed from the pelt board bag rather than being removed together with the pelt from the pelt board. The technical conflict between on the one hand an easy mounting of the pelt board bag on the pelt board prior to the mounting of the pelt externally relative to the pelt board bag and on the other hand the retaining of the pelt board bag after the drying of the pelt without removing the pelt board bag sticking to the pelt is further exaggerated in accordance with today's standard of pelt boards, which are collapsible pelt boards, i.e. at the time of applying the pelt board bag, the pelt board is non-collapsed or expanded, whereas at the time the pelt is removed and the pelt board bag should stay or be retained on the pelt board, the pelt board is collapsed, which causes a reduced contact between the inner side of the pelt board bag and the reduced—as compared to the non-collapsed or expanded state of the pelt board—outer surface of the pelt board.

In accordance with specific examples described in the above-listed prior art, the pelt board bags have been suggested produced as bags, which are configured in conformity with the outer surface of the non-collapsed or expanded pelt board, i.e. having a configuration in conformity with the configuration or shape of the non-collapsed or expanded pelt board, which evidently highly increases the possibility that the pelt board bag will be loosened from its contact with the pelt board at the time the pelt board is collapsed as discussed above.

### SUMMARY

An object of the present invention is to provide a pelt board bag, which is kept in contact with and remains in contact with the pelt board at the time the pelt board is shifted to its collapsed state, and the pelt is removed from its tight contact with the outer surface of the pelt board bag.

It is an object of the present invention to provide a novel pelt board bag which on the one hand allows for an easy mounting of the pelt board bag on the pelt board, the pelt board being in its non-collapsed or collapsed state and which on the other hand remains safely on the pelt board at the time the pelt board bag is removed.

The above objects together with numerous other objects, features and advantages, which will be evident from the below description of the present invention are, according to a first aspect of the present invention, obtained by a pelt board bag of a fat absorbing and optionally and preferably also moisture and water absorbing material for use in combination with and applied externally to a pelt board for the tanning and drying of a pelt applied externally to the pelt board bag, said bag comprising:

i) a pair of oppositely positioned and substantially coextensively extending, elongated sheets of said material,

ii) said pair of sheets being joined together along opposite longitudinal edges and defining in a first state a flat two-layer structure and in a second state a basically tubular state,

iii) said pair of sheets defining opposite first and second ends, said first end constituting a narrow open end constituting a top end when used in combination with said pelt board and said second end constituting a broader bottom end when used in combination with said pelt board, said pair of sheets defining in said second state an inner perimeter varying from said first narrow end to said broader second end, and

iv) said pair of sheets or at least one of said pair of sheets having a region at a specific inner perimeter, said region being provided with slits, oblong apertures, embossings, score lines or folds or combinations thereof allowing said region to be expanded at least in one direction longitudinally or transversely when in said second state.

According to the teachings of the present invention, the pelt board bag is basically of a structure which is undersized as compared to the pelt board, in particular undersized relative to the pelt board being in the non-collapsed or expanded state, and the pelt board bag being provided with the provisions of expandable or deformable parts constituted by the region including the slits, oblong apertures, embossings, score lines or folds, which allow the pelt board bag to be expanded when mounted on the pelt board or allows the pelt board bag to expand when applied to the collapsed pelt board prior to the pelt board being shifted from its collapsed state to its non-collapsed or expanded state.

The region constituting an expandable or deformable part or including the expandable or deformable part or parts may as stated above include slits, oblong apertures, embossings, score lines or folds. The slits, oblong apertures, embossings or score lines may, as will be discussed below, have different orientations as compared to the longitudinal direction or extent of the pelt board bag, whereas the folds which may be constituted by overlayered parts of the material from which the pelt board bag is produced may serve to allow the entire pelt board bag structure to be unfolded by the expansion for adjusting the size and configuration of the pelt board bag to the configuration and size of the pelt board at the time the pelt board bag is applied to the pelt board or after the pelt board bag has been applied and the pelt board is shifted from its collapsed state to its non-collapsed or expanded state.

The region characteristic of the present invention may constitute a fairly small area or region along the longitudinal extent of the pelt board bag, however, according to specific embodiments to be described below with reference to the drawings, the region constitutes almost the entire outer surface of the pelt board bag.

Provided the region has a fairly large extent, the region will, according to the advantageous and preferred embodiments of the pelt board bag according to the present invention, be bound by two inner perimeters along the longitudinal extent of the pelt board bag. It is of course to be understood that the pelt board bag according to the present invention may include more than a single region allowing for the expansion when applying the pelt board bag to the pelt board as several regions may be located along the longitudinal extent of the pelt board bag for providing the intentional expansion of the region or the regions at positions dedicated for the expansion purpose and defined primarily from the outer configuration and dimensions of the pelt board to which the pelt board bag is to be applied and in combination with which the pelt board bag is to be used.

In accordance with further characteristics of the pelt board bag according to the present invention, the pelt board bag may have—when in the second state—an overall conical configuration or a configuration composed of one or more cones and/or circular cylindrical section for allowing the pelt board bag to be configured and shaped in accordance with the pelt board with which the pelt board bag is to be used, and the cones and/or circular cylindrical sections provided by the pelt board bag in the second state of the pelt board bag may constitute sections including the region or regions characteristic of the present invention or interconnecting two or more regions or constitute non-expandable part or parts of the pelt board bag.

In a specific embodiments allowing the pelt board bag to be used in combination with a pelt board such as the pelt board implemented in accordance with the standard defined by Kopenhagen Fur A/S, the region is provided at a conical part of the pelt board bag such as a part corresponding to a tapered part of said pelt board or at a transition from a higher taper to a lower taper corresponding to the transition at the pelt board between a tapering part and a non-tapering part.

The expansion of the region characteristic of the pelt board bag according to the present invention may be provided for allowing expansion longitudinally or transversely and in order to provide the longitudinal and/or transversal expansion, the slits, oblong apertures, embossings or score lines of the region may extend transversely or longitudinally, respectively, relative to the pelt board bag. Alternatively, according to a further embodiment of the pelt board bag according to the present invention, the slits, oblong apertures, embossings or score lines are provided as sloping slits oblong apertures, embossings or score lines for allowing expansion in the longitudinal direction and/or simultaneously in the transversal direction.

According to a specific feature of the pelt board bag of the present invention, it has been realized that slits, oblong apertures, embossings or score lines simply cut into the material such as the paper material from which the pelt board bag is produced and may give origin to tearing the sheet material when expanding the region of the pelt board bag, and in order to prevent such tearing of the sheet material, e.g. the paper material from which the pelt board bag is produced, the slits, oblong apertures, embossings or score lines may be provided with rounded apertured ends simply for preventing the tearing propagation.

The slits, embossings or score lines are as such preferably made as linear slits, embossings or score lines, respectively, though curved or otherwise configured slits, embossings or score lines may be provided, e.g. for combining the feature of the longitudinally and transversely extending slits, embossings or score lines for providing expansion in the transverse and longitudinal directions of the pelt board bag.

The pelt board bag may as such be produced from standard materials such as paper or cardboard for providing a disposable bag as the material of the pelt board bag will be soaked by fat after the drying of the pelt has taken place. According to an alternative embodiment, the pelt board bag may be made from synthetic or natural fibers or a combination of fibers and paper or cardboard material and provided synthetic or natural fibers be used, the pelt board bag may be a non-disposable bag, which after use may be rinsed or cleaned for allowing for more than a single use.

The assembling of the sheets of the pelt board bag into the pelt board for allowing the pelt board to be shifted from its first state constituting a flat two-layer structure into a second state of a basically tubular state, well-known assembling techniques such a gluing, welding or hinge connections may be used for joining the sheets of the pelt board bag along the opposite longitudinal edges. It is to be understood, however, that the pelt board bag as such may be assembled from more than two sheets as one of the sheets or both sheets may themselves be assembled from two or more parts such as two parts being positioned side-by-side relative to the longitudinal direction of the pelt board bag or alternatively or in addition constituted by parts which are positioned overlayered or positioned end-to-end along the longitudinal direction of the pelt board bag.

The above objects together with numerous other objects, features and advantages, which will be evident from the below description of the present invention are, according to a second aspect of the present invention, obtained by an assembly of a pelt board bag of a fat absorbent and optionally and preferably also moisture and water absorbent material and a pelt board for use in combination with said pelt board bag for applying said pelt board bag externally to said pelt board for tanning and drying of a pelt applied externally to said pelt board bag, said bag comprising:

i) a pair of oppositely positioned and substantially coextensively extending, elongated sheets of said material,

ii) said pair of sheets being joined together along opposite longitudinal edges and defining in a first state a flat two-layer structure and in a second state a basically tubular state,

iii) said pair of sheets defining opposite first and second ends, said first end constituting a narrow open end constituting a top end when used in combination with said pelt board and said second end constituting a broader bottom end when used in combination with said pelt board, said pair of sheets defining in said second state an inner perimeter varying from said first narrow end to said broader second end,

iv) said pair of sheets or at least one of said pair of sheets having a region at a specific inner perimeter, said region being provided with slits, oblong apertures, embossings, score lines or folds or combinations thereof allowing said region to be expanded at least in one direction longitudinally or transversely when in said second state, and

v) said pelt board being shiftable between a collapsed state and a non-collapsed state, and said pelt board bag being applicable externally to said pelt board when in said collapsed state without expanding said region and said region being expanded when said pelt board bag is in said non-collapsed state or is caused to be expanded when shifting said pelt board from said collapsed state to said non-collapsed state.

The assembly according to the second aspect of the present invention may as such be implemented including any of the above-described advantageous features of the pelt board bag according to the first aspect of the present invention. In addition, the assembly according to the second aspect of the present invention may have any of the features of the pelt board itself defined in and described in the applicant's previously filed international patent application number PCT/EP2015/056431, International Publication No. WO/2015/144774, the disclosure of which is incorporated herein by reference in its entirety.

### BRIEF DESCRIPTION OF THE DRAWINGS

The present invention is now to be further described with reference to the drawings, in which:

FIG. 1 shows in an elevational and schematic view a pelt board and a first embodiment of a pelt board bag according to the present invention shown from its opposite facial sides,

FIGS. 2A, 2B and 2C are schematic views illustrating the first embodiment of a pelt board bag also shown in FIG. 1 applied to the pelt board also shown in FIG. 1 and in FIG. 2B illustrating a specific feature of the pelt board bag, namely the feature of allowing the pelt board bag to adjust its configuration to the pelt board,

FIGS. 3A, 3B and 3C are schematic views similar to the views of FIGS. 2A, 2B and 2C respectively, illustrating an improper positioning of the pelt board bag relative to the pelt board in which position no adjustment of the configuration of the pelt board bag is taking place,

FIG. 4A is a schematic view illustrating the sequence of applying firstly the pelt board bag to the pelt board and secondly applying the pelt to the pelt board bag previously applied to the pelt board,

FIG. 4B is a schematic and vertical sectional view illustrating on advantageous feature of the pelt board bag allowing for a closing off of the mouth opening of the pelt,

FIGS. 5A and 5B are schematic views illustrating a further advantageous feature of the pelt board bag according to the present invention of simplifying the technique of applying the pelt board bag to the pelt board,

FIGS. 6A, 6B and 6C are schematic views of an alternative embodiments of the pelt board bag according to the present invention,

FIGS. 7A-7J are schematic views similar to the view of FIG. 1 illustrating modified or alternative embodiments of the pelt board bag according to the present invention and schematically illustrating its advantageous ability to adjust its configuration to the pelt board to which the pelt board bag is applied,

FIGS. 8A-8D are schematic views illustrating alternative embodiments or configurations of the pelt board bag according to the present invention,

FIGS. 9A-9E are further alternative embodiments or configurations of the pelt board bag according to the present invention, and,

FIGS. 10A and 10B are still further alternative embodiments or configurations of the pelt board bag according to the present invention.

### DETAILED DESCRIPTION

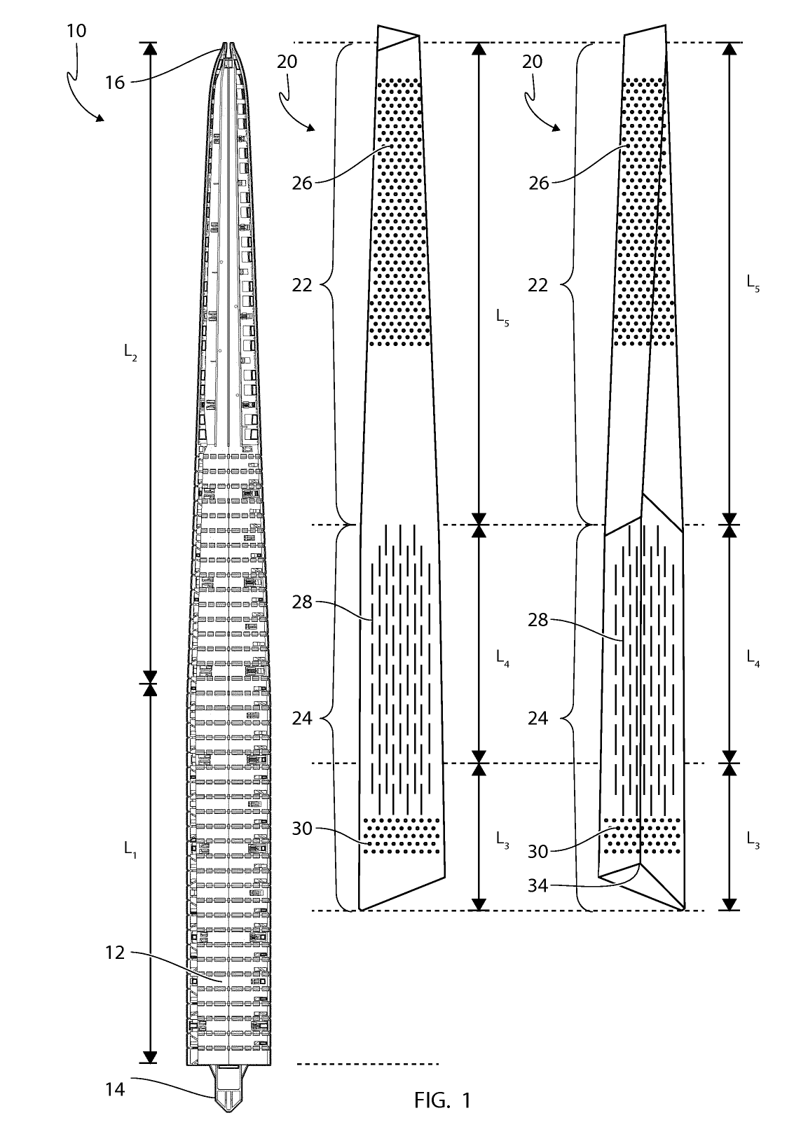

On the left-hand side of FIG. 1, a pelt board 10 is shown, which pelt board constitutes a pelt board implemented in accordance with the teachings described in the applicant's previously filed international patent application, application number PCT/EP2015/056431. The detailed description of the pelt board is to be found in International Application No. PCT/EP2015/056431, International Publication No. WO/2015/144774; however, a few essential technical features are to be mentioned in the present context.

The pelt board 10 is basically composed of three components, namely two identically configured convex plates, one of which is shown in FIG. 1 and designated the reference numeral 12, which is assembled to an identical rear plate by the corporation with a central rod-shaped element having at its lower end a protruding connector element 14.

The pelt board 10 is as such an expandable or collapsible pelt board in which the two faces are shifted sidewise relative to one another for establishing an expanded state shown in FIG. 1 in which a pelt board and a pelt is to be applied. In FIG. 1, two dimensions, L1 and L2 are indicated, which dimensions in the presently preferred embodiment of the pelt board 10 are 492 mm and 900 mm, respectively, as the length L2 is a standard measure determined by the standard established by Kopenhagen Fur A/S, whereas the length L1 is determined in accordance with empirical experiments performed by the applicant company.

In FIG. 1 is further shown a first embodiment of a pelt board bag, which is designated the reference numeral 20 in its entirety. The first embodiment 20 of the pelt board bag is basically construed by a conical structure composed of a top part 22 and a bottom part 24 as the top part 22 has a higher taper than the lower part 24 for providing a configuration partly resembling the top section of the pelt board 10. From the drawings FIG. 1 it is evident that the top part 22 of the pelt board bag 20 does not lengthwise correspond to the top section of the length L2 of the pelt board 10 since the length of the top part 22 of the pelt board bag 20 is indicated by L5 and is in the presently implemented embodiment of the pelt board bag 20 constituted by a length of 831 mm.

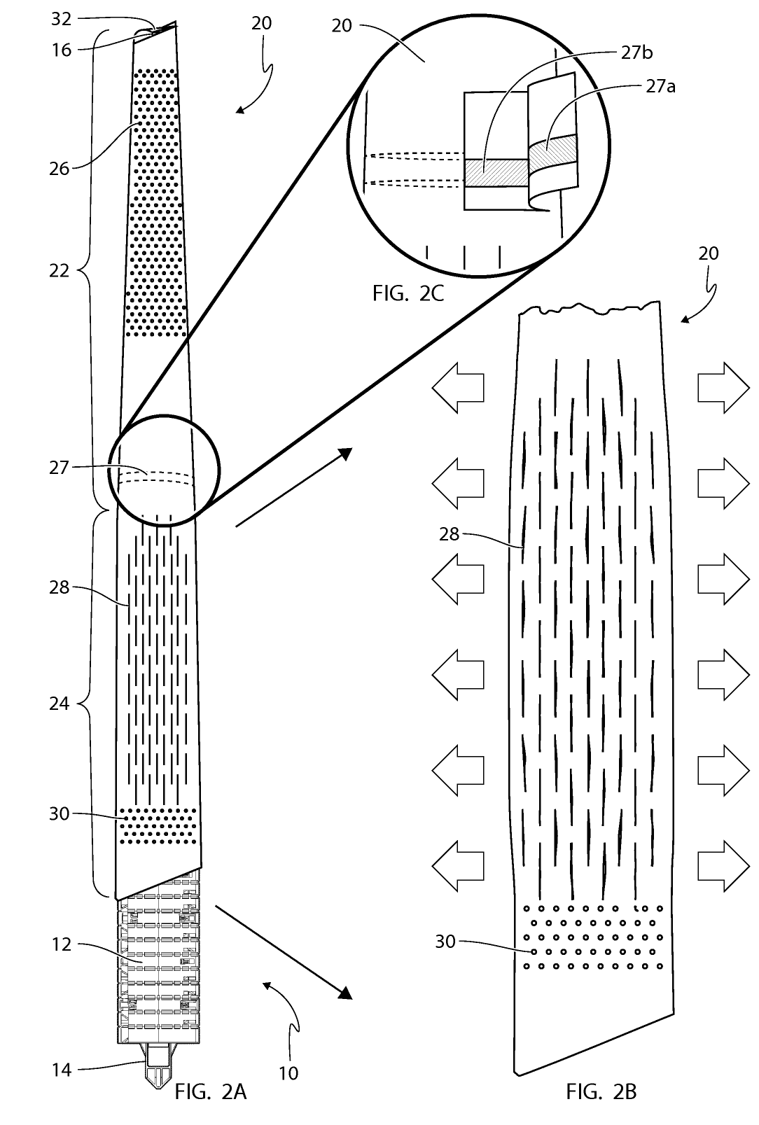

The lower part 24 of the pelt board bag 20 has a total length L3+L4 of 521 mm. The imaginary borderline between the lengths L3 and L4 of the bottom part 24 is constituted by the inner circumference of the bag being 250 mm, which corresponds to the standard width of the pelt board 10 in its expanded state as defined by the standard of Kopenhagen Fur A/S. As will be readily understood from the drawings FIG. 1, the conical pelt board bag 20 is due to its minor width as compared to the width of the expanded pelt board 10 of a structure which will be positioned tightly fixed to the pelt board 10 and necessitates, as will be described below with reference to FIGS. 2A, 2B and 2C, a kind of adjustment of the configuration of the pelt board bag for allowing the pelt board bag to be applied in its intentional position relative to the pelt board.

As is evident from FIG. 1, the pelt board bag 20 further exhibits in its top part 22 a apertured or perforated upper end section, which is positioned in an area to be covered by the front legs and the adjacent part of the leg which is applied to the pelt board having a pelt board bag 20 positioned between the pelt board 10 and the pelt. One of the apertures of the apertured or perforated section of the top part 22 is designated the reference numeral 26.

Below the apertured or perforated section of the top part 22 of the pelt board bag 20, a non-perforated section is provided. The lower part 22 of the pelt board bag 20 is in its major extend provided with lengthwise oriented cuts, one of which is designated the reference numeral 28.

The longitudinally extending slits 28 serve, as will be described below, the purpose of allowing the pelt board bag 20 to accommodate a configuration or adjust its transversal dimension to the pelt board 10 and in doing so providing a tight fit relative to the pelt, which ensures firstly a proper fixation of the pelt board bag 20 relative to the pelt prior to applying the pelt to the outside of the pelt board bag 20, and further ensures that the pelt board bag is kept in position on the pelt board 10 after the pelt has been dried and is removed from the pelt board bag which simplifies the removal of the pelt board bag after the tanning and drying operation has been completed as is in itself well-known in the art.

Below the longitudinal extending slits 28, an aperture or perforated section is provided in the lower part 24 of the pelt board bag 20, which aperture or perforated section has a single aperture designated the reference numeral 30.

The pelt board bag 20 shown in FIG. 1 further exhibits two distinct and highly advantageous geometrical features, as the configuration of the uppermost end of the conical top part 22 of the pelt board bag 20 as the two sides of the pelt board bag are of different lengths providing an extension flap designated the reference numeral 32 and constituted by the longer side of the pelt board bag. The opposite end of the pelt board bag exhibits a notch 34 as the one side of the pelt board bag 20, which side provides the flap 32 is cut so as to diminish the bottom length of the pelt board bag relative to the length of the opposite side of the pelt board bag. The advantageous features of the flap 32 and the notch 34 will be described below.

In FIG. 2A, the first embodiment 20 of the pelt board bag is shown applied to the pelt board 10 in the intentional position of the pelt board bag 20 relative to the pelt board 10 as the outermost top end 16 of the pelt board 10 is exposed at the upper end of the pelt board bag, however, covered below the turned over flap 32. Since the width of the pelt board bag 20—except for the lowermost section of a length of L3—is narrower than the width of the pelt board 10, the pelt board bag exhibits the advantageous feature of allowing the pelt board bag to adjust its width or dimensions to the pelt board to which it is applied. This feature is shown schematically and somewhat exaggerated in FIG. 2B in which the spreading of the upper section of the lower part 24 of the pelt board bag 20 is shown as the longitudinal slits 28 are caused to be opened providing a widening of the upper section of the lower part 24 of the pelt board bag 20 for accommodating the size and the configuration of the pelt to the wider size and dimensions of the pelt board 10. In FIG. 2A and further, in an enlarged sectional view of FIG. 2C, a further feature of the first embodiment 20 of the pelt board bag according to the present invention is shown, which feature serves to define a specific positioning of the pelt board bag relative to the pelt board 10 by the provision of a strengthening band 27 provided as a layer or a glued reinforcing layer applied internally in the pelt board bag material as is illustrated in FIG. 2C. The strengthening band 27 is provided at a position along the conical part or top part 22 of the pelt board bag for defining the specific and intentional positioning of the pelt board bag 20 relative to the pelt board 10 and allowing the intentional proper expansion of the upper section of the lower part 24 of the pelt board bag 20 by the presence of the longitudinal slits 28.

Apart from the ability of adjusting the transverse dimensions of the pelt board bag 20 relative to the pelt board 10, the longitudinal slits 28 also serve the purpose of allowing air to be vented through the slits similar to the well-known venting of air through the aperture or perforation 26 and 30, respectively, of the pelt board bag 20. The pelt board bag may as such be made from any appropriate material and configured in accordance with the intentional application such as the example described above, the intentional use in combination with a Kopenhagen Fur A/S standardized pelt board and the materials used for the pelt board bag may preferably be paper or cardboard or combinations thereof or paper material including polymer fibers such as woven or non-woven polyethylene or polypropylene fibers.

The paper based pelt board bag is evidently serving the purpose of firstly drawing residual fat from the inner side of the pelt applied to the pelt board bag and in addition allowing water to be absorbed or transmitted and evaporated through the apertures or perforations and additionally the slits 28 described above. Provided the pelt board bag is made from a paper based material, the bag is evidently of the disposable kind, however, alternative material based on natural or synthetic fibers such as woven polyester or polypropylene fibers or natural cotton or similar fibers may be used for providing a non-disposable bag.

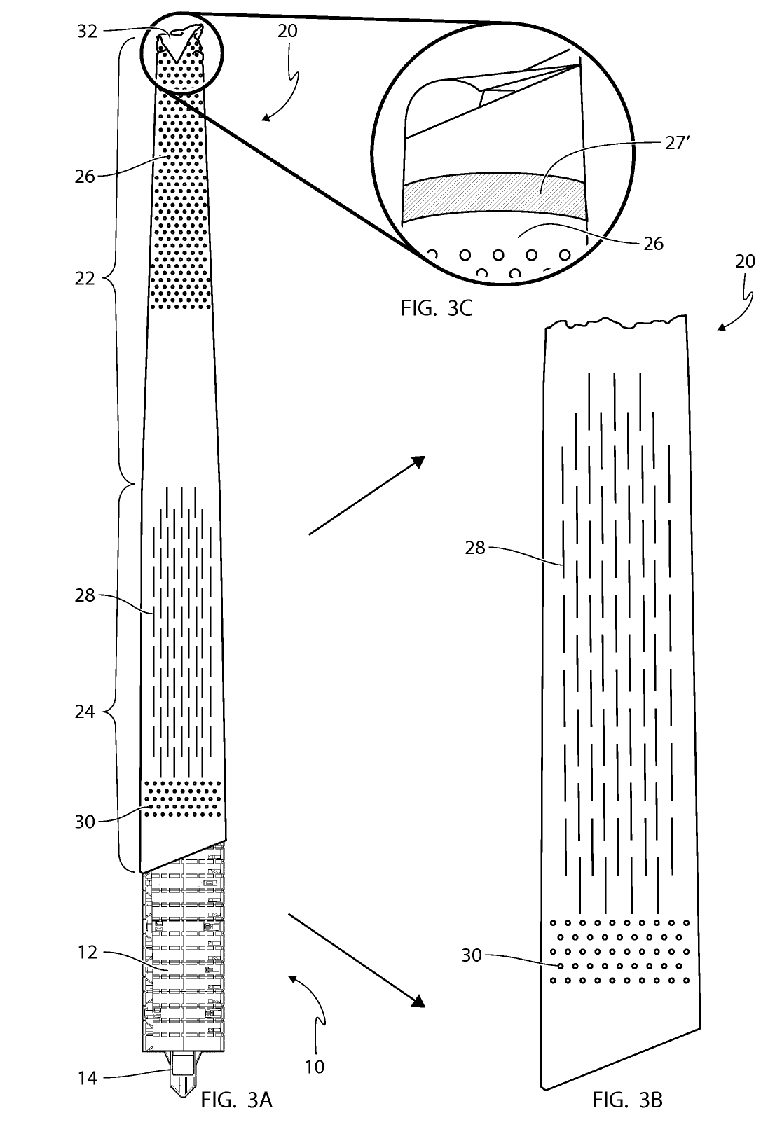

Provided the pelt board bag 20 is improperly positioned or applied to the pelt board 10 without stretching the pelt board bag properly downwardly towards the lower end of the pelt board, the pelt board bag may be applied as shown schematically in FIG. 3A in which configuration the pelt board bag provides a somewhat crumbled top end and reduces the intentional functionality of the vertical slits 28, which are—as is evident from FIG. 3B—not expanded for adjusting or adapting the configuration of the pelt board bag to the pelt board and failing to provide the increased air outlet area by the opening of the slits as is illustrated in FIG. 2B. In FIG. 3C, an enlarged view similar to the view of FIG. 2C illustrates an alternative location of the reinforcing band 27′ at a position along the conical part or the top part 22 of the pelt board bag 20, as in FIG. 3C, the reinforcing band 27′ is positioned above the aperture or perforated section of the top part 22 and applied as an external coating. In FIG. 3A, it is contemplated that the person positioning the pelt board bag 20 on the pelt board 10 is not utilising the feature of the strengthening band 27′, rather simply in an incorrect application of the pelt board bag simply slips the bag onto the pelt board 10 without forcing the pelt board bag to its intentional position, in which the strengthening band 27′ prevents any further downward motion of the pelt board bag 20 relative to the pelt board, unless an excessive force is applied to the pelt board bag 20, which causes a tearing apart of the whole pelt board bag.

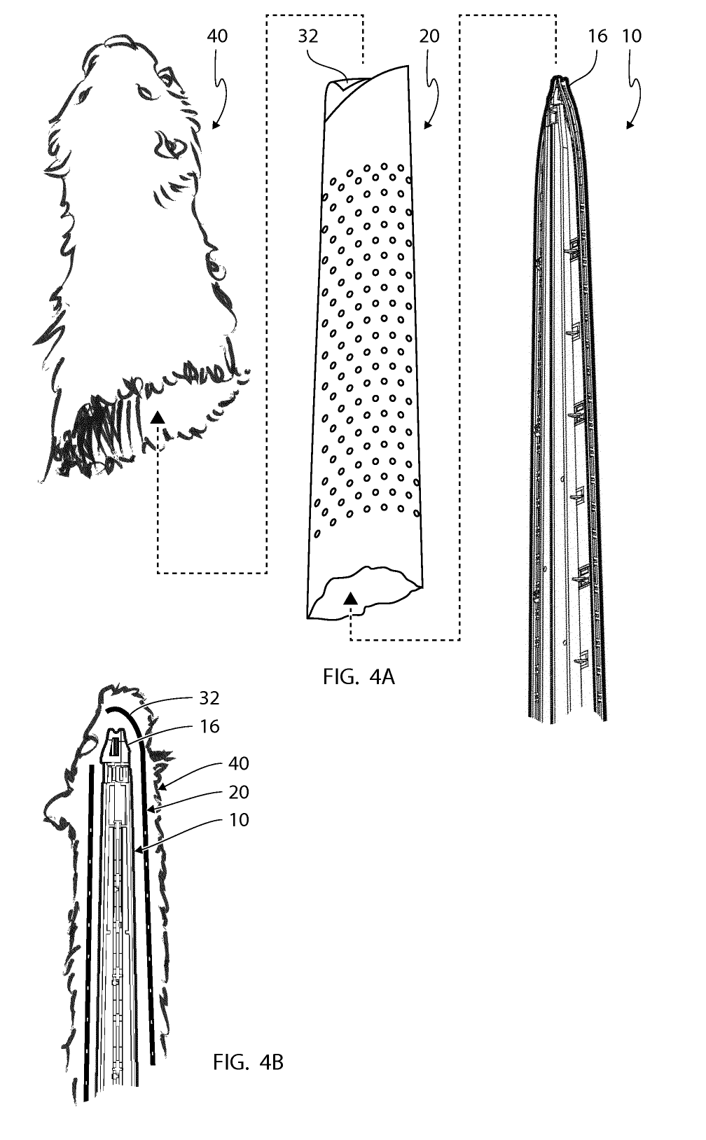

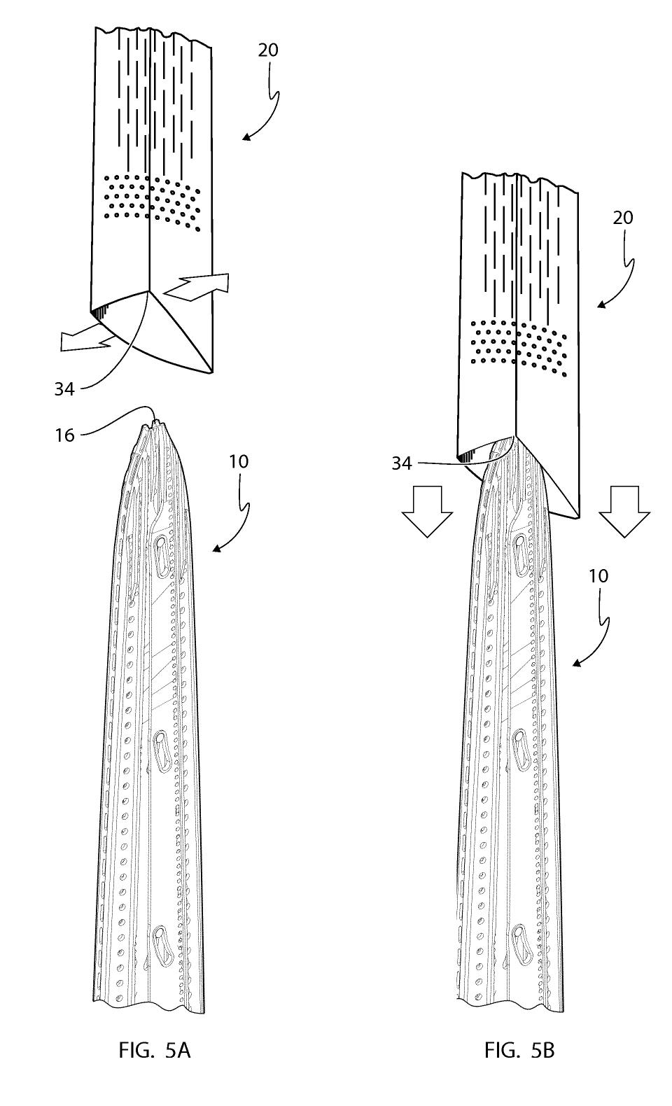

In FIG. 4A, the pelt board 10, the pelt board bag 20 and a pelt 40 are shown and a dotted line having a directional arrow indicates the intentional order of applying the pelt board bag 20 to the pelt board 10 and when applying the pelt 40 to the properly positioned pelt board bag 20 as is shown in FIG. 2A.

In FIG. 4B is shown a detail of the flap 32 of the pelt board bag 20, which flap—as is also shown in FIG. 2A—is turned over covering the uppermost end of the pelt board 10 and in doing so, closes off the mouth opening of the pelt 40 in order to prevent that a major part of the venting air which is forced into the interior of the pelt board bag 20 through the bottom connector 14 of the pelt board 10 and guided up through the interior of the pelt board 10 escapes through the mouth of the pelt 40 rather than being forced out through the apertures of the pelt board and through the intended air passages established by the apertures or perforations 26 and 30 and the expanded longitudinal slits 28.

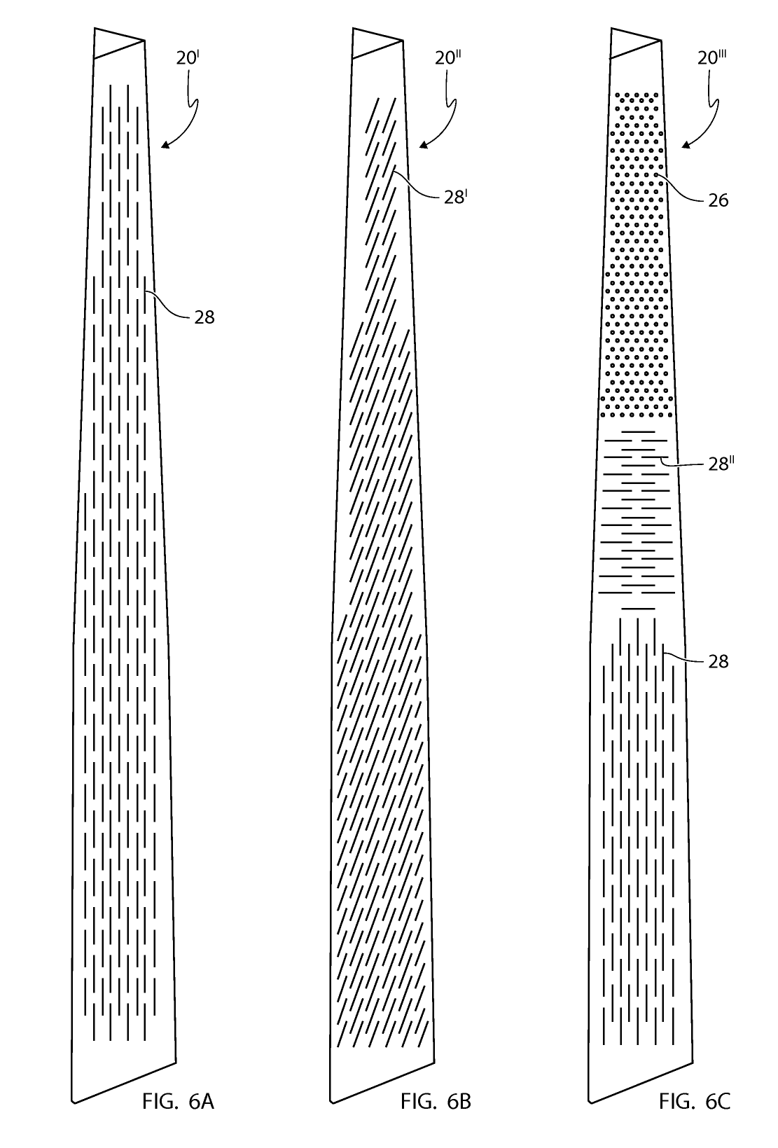

In FIGS. 5A and 5B, the pelt board 10 and the first embodiment of the pelt board bag 20 are shown illustrating an advantageous feature of the presence of the notch 34 provided in the pelt board bag at its lower end opposite the flap 32. The notch is as such provided in the one side of the pelt board bag and allows for an easy separation of the two opposite sheets of the pelt board bag 20 e.g. by simply pressing lightly at the edges of the pelt board bag 20.

After the slight separation of the two sheets of the pelt board bag 20 from one another—as illustrated in FIG. 5A—the pelt board bag 20 is pushed down on the expanded pelt board 10 as is illustrated in FIG. 5B or alternatively the collapsed or non-expanded pelt board 10 (not shown in the drawings) and indicated by two further arrows as the notch in the one sheet of the pelt board in FIGS. 5A and 5B—the sheet facing towards the viewer—allows for the ready and easy positioning of the pelt board bag 20 above and contacting the pelt board bag 20 with the uppermost end 16 of the pelt board 10.

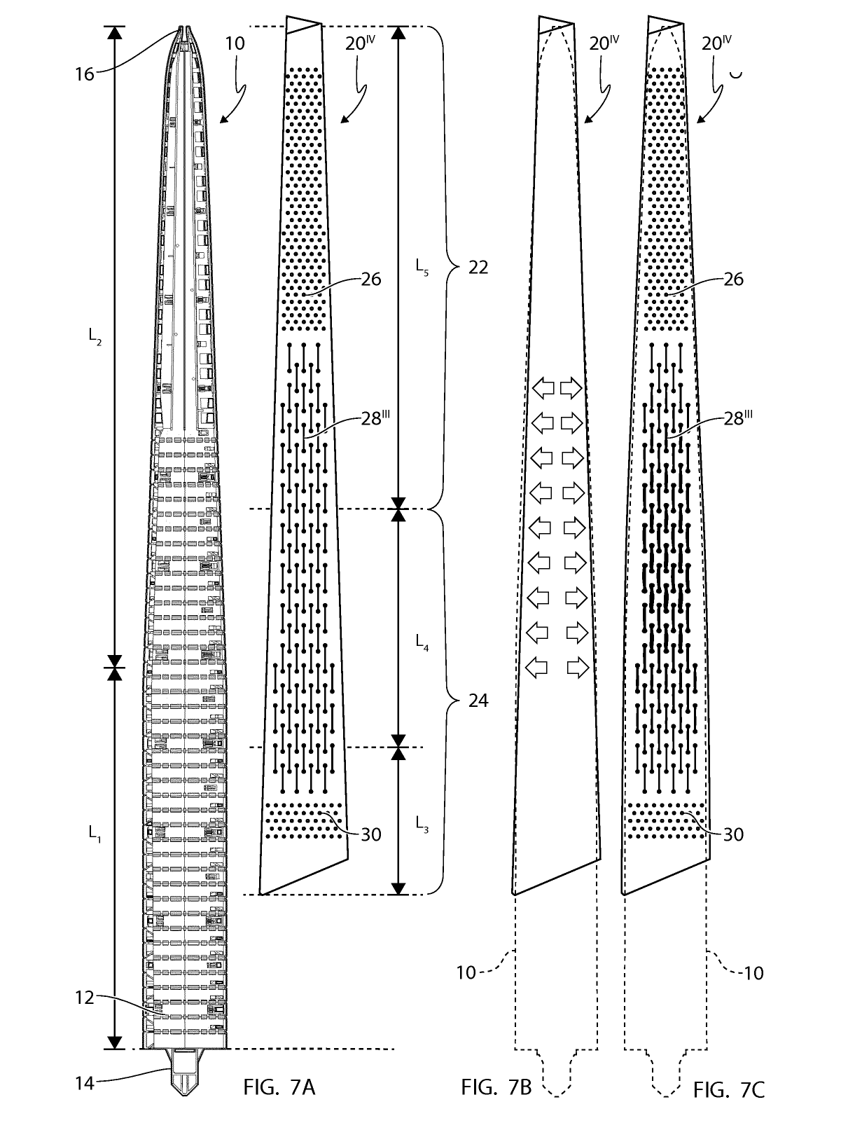

In FIGS. 6A, 6B and 6C, a second, a third and a fourth embodiment of the pelt board bag according to the present invention is shown designated the reference numerals 20′, 20″ and 20′″, respectively. In FIG. 6A-6C and in the further figures, components or elements identical to previously described components or elements, respectively, are designated the same reference numerals as previously used and no specific description of the component or element in question is presented except for specific purpose of understanding of a further functionality of the component or element in question, whereas components or elements corresponding to or having similar functions as previously described components or element, respectively, are designated the same reference numeral as previously used, however, added a marking for identifying the difference in geometrical configuration.

The second, third and fourth embodiment 20′, 20″ and 20′″, respectively, of the pelt board bag according to the present invention shown in FIGS. 6A, 6B and 6C, respectively, differ from the above-described first embodiment 20 in that the bags are provided with an increased number of elements allowing for the modification or change of configuration of the pelt board bag for allowing the pelt board bag to be tightly mounted on a corresponding pelt board, being an expanded or collapsed pelt board.

In FIG. 6A, the entire outer surface and similarly the opposite surface of the pelt board bag 20′ is provided with an increased number of longitudinal slits 28 covering the entire outer surface of the pelt board bag and similarly the opposite side or the opposite sheet of the pelt board bag simply allowing for the provision of expandable areas of the entire pelt board bag for accommodating the configuration of the pelt board bag 20′ to the configuration of the pelt board with which the pelt board bag is to be used and at the same time providing the air venting capability at the entire structure of the pelt board bag. The pelt board bag 20′ is—compared to the pelt board, an expanded pelt board or a collapsed pelt board—an undersized pelt board bag.

Whereas the slits 28 shown in the first embodiment 20 described above and also in the second embodiment 20′ described with a reference to FIG. 6A, are extending longitudinally allowing only for the expansion transversely of the sheets of the pelt board bag or the specific areas of the pelt board bag in question, the third embodiment 20′ of the pelt board bag shown in FIG. 6B is provided with modified slits extending diagonally relative to the longitudinal axis of the pelt board bag and being provided on both sides of the pelt board bag. The diagonal slits 28′ allow for an expansion due to the separation of the sheet material adjacent the slits, in the longitudinal direction and also in the transverse direction of the pelt board bag 20″.

It is of course evident that the provision of the longitudinally extending slits and the diagonally extending slits shown in FIGS. 6A and 6B, respectively, may be dedicated to specific areas of the pelt board bag rather than being provided at the entire surface of the two sheets of the pelt board bags. Furthermore, the diagonally extending slits 28′ may be modified into having the opposite diagonally extending orientation or be combined with longitudinally extending or transversely extending slits.

In FIG. 6C, the fourth embodiment 20″ of the pelt board bag according to the present invention is shown including in its top part apertures identical to the apertures described above with a reference to FIG. 1 and at its lower part and at the lower section of the top part of the pelt board bag corresponding to the non-apertured or non-perforated area of the top part of the pelt board bag 20 shown in FIG. 1, the fourth embodiment 20′″ of the pelt board bag according to the present invention is provided with transverse slits 28″ serving the purpose of allowing the pelt board bag 20′″ to be slightly extended longitudinally due to the separation of the slits 28″. In the fourth embodiment 20′″ of the pelt board bag according to the present invention shown in FIG. 6C, the entire lower part of the pelt board bag is provided with slits extending longitudinally, i.e. slits 28 serving the same purpose as the slits described above with reference to FIG. 1 and also shown in FIG. 6A.

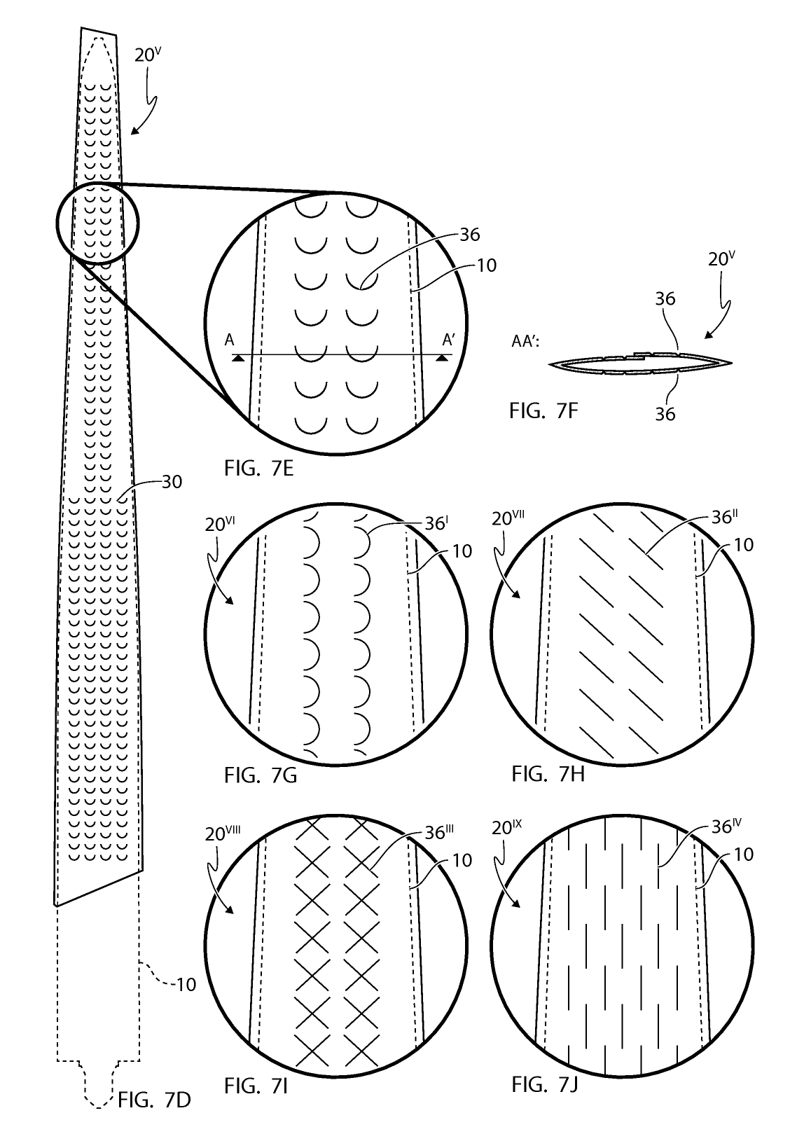

In FIGS. 7A, 7B and 7C, a further or fifth embodiment of the pelt board bag according to the present invention is shown designated the reference numeral 20^{iv}. The fifth embodiment 20^{iv} of the pelt board bag according to the present invention differs from the above-described first embodiment 20 shown in FIG. 1 in that the longitudinally extending slits 28′″ are also provided covering the major part of the lower part 24 of the pelt board and also the lower section of the top part 22 of the pelt board. In addition, the slits are provided with circular end holes which are believed to provide a tear preventing feature as the circular end openings of the slits prevent the material from being torn at the time of separating the material adjacent a specific slit.

In FIG. 7B, the fifth embodiment 20^{iv} of the pelt board according to the present invention is shown schematically overlaid the expanded pelt board 10 shown in the left-hand part of FIG. 7A, and from this schematic overlay view, it becomes evident how the pelt board bag 20^{iv} has to be widened within the area provided with the slits 28′″ and above the section of the lengths L3. The fifth embodiment 20^{iv} further differs from the above-described twin conical bags shown in all previous discussed FIGS. 1-6C in that the bag is a bag having a single taper which, from the view of producing the bag, makes the assembly more easy and also reduces waste of material when cutting the two sides of the bag from the material, which is preferably paper or cardboard-like material.

In FIG. 7C, a view similar to the view in FIG. 7B is presented illustrating the actual whitening of the pelt board bag 20^{1v} in the central section as indicated by arrows in FIG. 7B.

In FIG. 7D, a sixth embodiment 20^{V} of the pelt board according to the present invention is shown schematically overlaid the expanded pelt board 10 shown in dotted line in the lower left hand part of FIG. 7D. The pelt board bag 20^{V} is as distinct from the above described embodiments, in which slits or cuts are provided through the paper material of the pelt board bag provided with a plurality of embossings or score lines 36 allowing for the tearing of the material along the embossings or the score lines, as the pelt board bag is to be expanded as it is positioned on the pelt board 10. In FIG. 7E, an enlarged sectional view of a segment of the upper conical part of the pelt board bag 20^{V} is shown, in which the marking AA′ indicates a sectional line, along which the section AA′ shown in FIG. 7F is provided. In FIG. 7F, the embossings or score lines are shown indicating the lack of any puncturing or aperturing of the paper material of the pelt board bag 20^{V}.

In FIG. 7G, an alternative seventh embodiment 20^{VI} is shown, in which the embossings or score lines 36′ are arranged perpendicularly relative to the orientation of the score lines 36 shown in FIGS. 7D, 7E and 7F.

In FIG. 7H, an eighth embodiment 20^{VII} of the pelt board bag according to the present invention is shown, in which the embossings or score lines 36″ are constituted by angularly orientated linear segments and in a further or ninth embodiment 20^{VIII} shown in FIG. 7I, the embossings or score lines 36^{III} are constituted by crossed linear segments serving to be torn up as apertures or linear slits, as the pelt board bag 20^{VIII} is expanded.

In FIG. 7J, a tenth embodiment of 20^{IX} of the pelt board bag according to the present invention is shown, in which the embossings or score lines are constituted by linear segments 36^{1v} orientated along the longitudinal axis of the pelt board bag 20^{IX}.

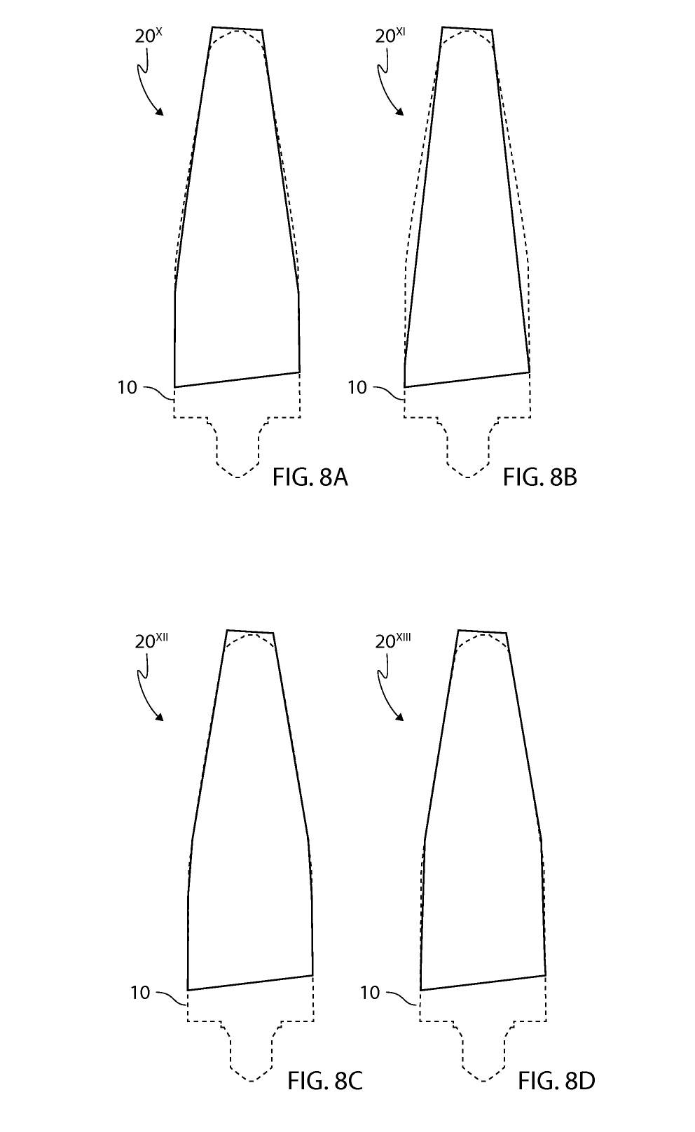

In FIGS. 8A, 8B, 8C and 8D, an eleventh embodiment 20^{X}, a twelfth embodiment 20^{XI}, a thirteenth embodiment 20^{XII} and a fourteenth embodiment 20^{XIII} of the pelt board bag according to the present invention are shown, respectively, illustrating different configurations or outlines of the outer contour of the pelt board bag relative to the outer contour of the expanded pelt board 10. The eleventh embodiment 20^{X} exhibits a narrowed section at the central part of the pelt board bag and similarly, the twelfth embodiment 20^{XI} of the pelt board bag exhibits an elongated conical section of a longitudinal extent far exceeding the extent of the conical upper part of the pelt board 20 and consequently, the twelfth embodiment 20^{XI} of the pelt board bag exhibits a conical extension exceeding the length L2 of the pelt board 10 shown in FIG. 1.

The thirteenth embodiment 20^{XII} of the pelt board bag shown in FIG. 8C is a double conical variant, in which a lower tapering part of the pelt board bag bridges the upper higher taper conical part with the lower non-conical part. The fourteenth embodiment 20^{XIII} of the pelt board bag shown in FIG. 8D is a double conical variant, in which the lower section of the pelt board bag corresponds to the section 24 of the pelt board bag 20 shown in FIG. 1.

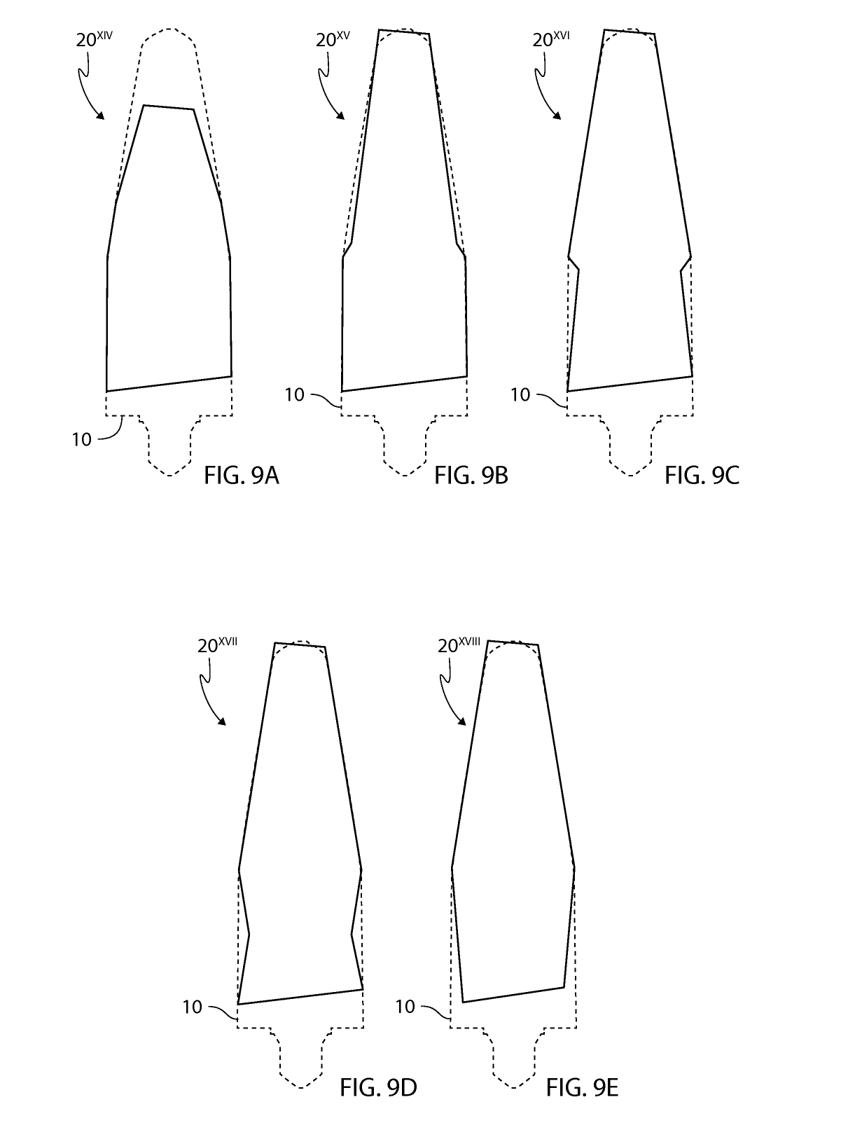

In FIGS. 9A, 9B, 9C, 9D and 9E a fifteenth embodiment 20^{VIV}, a sixteenth embodiment 20^{XV}, a seventeenth embodiment 20^{XVI} an eighteenth embodiment 20^{XVII} and a nineteenth embodiment 20^{XVIII} are shown, respectively, in which embodiments different configurations of the upper part and the lower part of the pelt board bag are narrowed for providing the undersized part serving to cause the pelt board bag embodiment to be deformed into correspondence with the underlying pelt board 10. In the fifteenth embodiment 20^{XIV} shown in FIG. 9A, the upper part is a double conical part, in which the upper higher tamper conical part is to be deformed into the configuration of the pelt board 10 by the opening of the slit or oblong apertures or tearing open the paper material of the pelt board bag by the presence of the embossings or score lines described above.

Similarly, in the sixteenth embodiment 20^{XV} shown in FIG. 9B, the upper part of the pelt board bag is a double conical version having a minor transition part between the upper conical part and the lower non-conical part of the pelt board bag.

In the seventeenth, eighteenth and nineteenth embodiments 20^{XVI}, 20^{XVII} and 20^{XVIII}, respectively, shown in FIGS. 9C, 9D and 9E, respectively, the lower part of the pelt board bag is configured for the conversion from the original configuration into a stretched out configuration corresponding to the outline of the pelt board 10. The seventeenth embodiment 20^{XVI} shown in FIG. 9C constitutes so to speak a mirror image or an inverted variant of the eighteenth embodiment 20^{XV} shown in FIG. 9B and the seventeenth embodiment 20^{XVII} shown in FIG. 9D of the pelt board bag according to the present invention has a lower section of two different tapers, the one narrowing the section and the lower second section broadening the section.

In FIG. 9E, the nineteenth embodiment 20^{XVIII} of the pelt board bag according to the present invention has a lower inversely tapering lower section to be deformed by the separation of the slits, oblong apertures or tearing apart of the embossings or score lines as described above for bringing the pelt board bag into conformity with the outline of the underlying pelt.

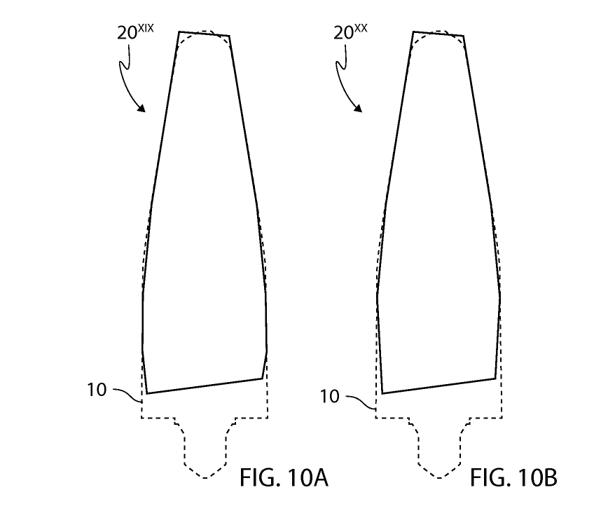

Finally, in FIGS. 10A and 10B, a twentieth an a twenty-first embodiment 20^{XIX} and 20^{XX}, respectively, are shown exhibiting a multiplicity of sections for conforming the pelt board bag in question to the underlying pelt board 10.

In FIG. 10A, the twentieth embodiment 20^{XIX} has a top part of a conical configuration in conformity with the outline of the underlying pelt board 10 and a somewhat lower taper conical section bridging the conical top part of the pelt board bag to a third section of a substantially rectilinear configuration and at its lower end, the twentieth embodiment 20^{XIX} of the pelt board bag has a narrowing taper section or conical section serving to be expanded for allowing the pelt board bag to be converted into a configuration in conformity with the outline of the pelt board 10.

The twenty-first embodiment 20^{XX} of the pelt board bag shown in FIG. 10 differs from the embodiment shown in FIG. 10A in that the two lower parts or sections of the pelt board bag are substituted by a single inversely tapering conical part for being conformed by deformation into the configuration outline of the pelt board 10 by the separation of the slit or oblong apertures, the separation of the embossings or score lines as described above.

Although the above description has in greater details described specific and presently preferred embodiments of the pelt board bag according to the present invention, alternative materials apart from those mentioned above constituting reusable material based on synthetic or natural fibers may be used and apart from the above-described single conical embodiment or the dual conical versions described, different configurations are contemplated covered by the appending claims as long as the protective scope defining the particular feature characteristic of the present invention or providing at least a single section allowing the pelt board bag to be widened longitudinally or transversely or in both directions is fulfilled. It is further to be realized that the above described numerous embodiments may readily be combined by the combination of teachings from one embodiment into another embodiment as to the configuration of the slits or apertures or the provision of embossings or score lines to be torn open, or the configuration of the sections of the pelt board bag having two or more sections configured in conformity with the contour of the pelt board or having a contour different from the pelt board as described above with reference to the drawings. Any such embodiments readily deducible in accordance with the ordinary skill of a person in the art are considered to be encompassed by the appending claims.

1.-11. (canceled)

12. A pelt board bag configured to be applied externally to a pelt board for the tanning and drying of a pelt applied externally to the pelt board bag, the pelt board bag comprising:
a pair of oppositely positioned and substantially coextensively extending sheets of fat-absorbing material;
the pair of sheets being joined together along opposite longitudinal edges and defining in a first state a flat two-layer structure, and in a second state a substantially tubular structure;
the pair of sheets defining opposite first and second ends, the first end configured as an open top end, the second end being broader than the top end and configured as a bottom end, the pair of sheets defining in the second state an inner perimeter increasing from the first end to the broader second end; and
at least one of the pair of sheets having an expandable region at a specific inner perimeter thereof, the expandable region being expandable in at least one direction when the pair of sheets are in the second state.

13. The pelt board bag of claim 12, wherein the expandable region includes expansion features selected from the group consisting of one or more of slits, oblong apertures, embossings, score lines, and folds that allow the expandable region to be expanded in at least in one direction when in the pair of sheets are in the second state.

14. The pelt board bag of claim 12, wherein the pelt board bag defines a longitudinal extent, and wherein the expandable region is bounded by two inner perimeters along the longitudinal extent.

15. The pelt board bag of claim 12, wherein the pelt board bag defines, when in the second state, an overall conical configuration.

16. The pelt board bag of claim 12, wherein the expandable region is provided at a conical part of the pelt board bag.

17. The pelt board bag of claim 13, wherein the expansion features extend longitudinally relative to said pelt board bag.

18. The pelt board bag of claim 13, wherein the expansion features extend transversely relative to said pelt board bag.

19. The pelt board bag of claim 13, wherein the expansion features slope relative to a longitudinal direction of the pelt board bag.

20. The pelt board bag of claim 13, wherein the expansion features comprise substantially linear slits having rounded, apertured ends configured for preventing the propagation of tearing of the sheet material when the expandable region is expanded.

21. The pelt board bag of claim 12, wherein the material is selected from the group consisting of one or more of paper, cardboard, synthetic fiber material, and natural fiber material.

22. The pelt board bag of claim 12, wherein the pair of sheets are joined along the opposite longitudinal edges by at least one of gluing, welding, and an integral hinge connection between the pair of sheets.

23. An assembly for tanning and drying a pelt, comprising:
a pelt board; and
a pelt board bag of a fat absorbing material configured to be applied externally on the pelt board, the pelt board bag comprising a pair of oppositely positioned and substantially coextensively extending sheets of fat-absorbing material;
wherein the pair of sheets are joined together along opposite longitudinal edges and define in a first state a flat two-layer structure, and in a second state a basically tubular structure;
wherein the pair of sheets define opposite first and second ends, the first end configured as an open top end when the pelt board bag is applied externally on the pelt board, the second end being broader than the first end and configured as a bottom end when the pelt board bag is applied externally on the pelt board, the pair of sheets defining, in the second state, an inner perimeter increasing from the first end to the broader second end;
wherein at least one of the pair of sheets has an expandable region at a specific inner perimeter thereof, the expandable region being configured for expansion in at least in one direction when the pair of sheets are in the second state; and
wherein the pelt board is shiftable between a collapsed state and a non-collapsed state, the pelt board bag being applicable externally to the pelt board when in the pelt board is in the collapsed state without expanding the expandable region, and wherein the expandable region is expanded when the pelt board is shifted from the collapsed state to the non-collapsed state.

24. The assembly of claim 23, wherein the expandable region includes expansion features selected from the group consisting of one or more of slits, oblong apertures, embossings, score lines, and folds that allow the expandable region to be expanded in at least in one direction when in the pair of sheets are in the second state.

25. The assembly of claim 23, wherein the pelt board bag defines a longitudinal extent, and wherein the expandable region is bounded by two inner perimeters along the longitudinal extent.

26. The assembly of claim 23, wherein the pelt board bag defines, when in the second state, an overall conical configuration.

27. The assembly of claim 23, wherein the expandable region is provided at a conical part of the pelt board bag.

28. The assembly of claim 24, wherein the expansion features extend longitudinally relative to said pelt board bag.

29. The assembly of claim 24, wherein the expansion features extend transversely relative to said pelt board bag.

30. The assembly of claim 24, wherein the expansion features slope relative to a longitudinal direction of the pelt board bag.

31. The assembly of claim 24, wherein the expansion features comprise substantially linear slits having rounded, apertured ends configured for preventing the propagation of tearing of the sheet material when the expandable region is expanded.

32. The assembly of claim 23, wherein the material is selected from the group consisting of one or more of paper, cardboard, synthetic fiber material, and natural fiber material.

33. The assembly of claim 23, wherein the pair of sheets are joined along the opposite longitudinal edges by at least one of gluing, welding, and an integral hinge connection between the pair of sheets.
